(19) United States
(12) Patent Application Publication
(10) Pub. No.: US 2009/0010732 A1
(43) Pub. Date: Jan. 8, 2009

(54) Fixing clip for joining two superimposed flat components

(75) Inventor: Gerald Baumbach, Tabarz (DE)

Correspondence Address: BIRCH STEWART KOLASCH & BIRCH, PO BOX 747, FALLS CHURCH, VA, 22040-0747, US

(73) Assignee: EJOT GmbH & Co. KG, Bad Laasphe (DE)

(21) Appl. No.: 12/153,082

(22) Filed: May 13, 2008

(30) Foreign Application Priority Data
Jul. 2, 2007 (DE) 10 2007 030 613.1

(51) Int. Cl. F16B 1/00

(52) U.S. Cl. 411/19

(57) ABSTRACT

The invention relates to a fixing clip for joining two superimposed flat components each having one penetration in alignment with the other. The fixing clip is characterized by a mounting part with two arms for contact with the upper component and an expanding part attached to the mounting part for spring-loaded engagement of the lower component, wherein the mounting part with the expanding part forms a hole passage in alignment with the penetrations and the mounting part receives a cap screw, wherein said cap screw penetrates the two penetrations and the hole passage with a threaded shank and is adapted with its head between the two arms to engage the arms both in a pre-assembly position and also in a holding position. As the screw is screwed into the hole passage and as the expanding part expands, the screw transitions out of the pre-assembly position into the fixing position, in which the threaded shank holds the expanding part in its expanded position and presses the two components together.

The invention relates to a fixing clip for joining two superimposed flat components each having one penetration in alignment with the other.

Such fixing clips are frequently used to fix components with flat walls to other flat components. In this respect, reference is made to DE 619 487, which relates to a device for fixing the interior trim on body parts of motor vehicles. Said fixing clip, which maintains the two flat components not in superimposition but at a small distance from each other, consists essentially of an expanding spring which penetrates co-aligned penetrations in the two components and can be inserted with two outwardly spring-loaded arms and outwardly pointing bends into the penetrations and latches therein, wherein the projections hold one of the components in such a manner as to maintain the distance from the other component. There is no special locking of the known fixing clip in its position in which it holds the two components; the fixing clip can always be removed from the components by pressing together its relevant spring-loaded parts.

In contrast to the technical mode of action of the known fixing clip, the fixing clip according to the invention is, as stated hereinbefore, a fixing clip for joining two superimposed flat components, wherein said fixing clip, on the one hand, is intended to allow simple attachment to one of the two components and, on the other hand, is capable of securing the other component in a directly adjacent position by means of a catch mechanism, which can be opened only by releasing the catch. According to the invention, this is accomplished by a fixing clip characterized by a mounting part with two arms for contact with the upper component and an expanding part attached to the mounting part for spring-loaded engagement of the lower component, wherein the mounting part with the expanding part forms a hole passage in alignment with the penetrations and the mounting part receives a cap screw, wherein said cap screw penetrates the two penetrations and the hole passage with a threaded shank and is adapted with its head between the two arms to engage the arms both in a pre-assembly position and also in a holding position, out of which positions, as the screw is screwed into the hole passage and as the expanding part expands, the screw transitions into the fixing position, in which the threaded shank holds the expanding part in its expanded position and presses the two components together.

Said fixing clip is capable of assuming a pre-assembly position through simple insertion into the penetrations of the two components. By means of the screw with its head and the latching of the head in relation to the arms of the mounting part, the fixing clip is given a holding position, out of which it can be released only through intentional and deliberate loosening of the screw. This results in the simple assembly and secure fixing of the two components to each other, from which they can be released by loosening the screw.

For engagement by the head of the screw, the arms are advantageously provided with openings, said openings being engaged by the head of the screw.

The fixing clip may be a two-part component, consisting of mounting part and expanding part, the expanding part being insertable into the mounting part. Alternatively, however, it is possible for the fixing clip to be of one-piece design, for which purpose the expanding part and the mounting part are formed from one piece of sheet metal.

An illustrative embodiment of the invention is presented in the drawings, in which:

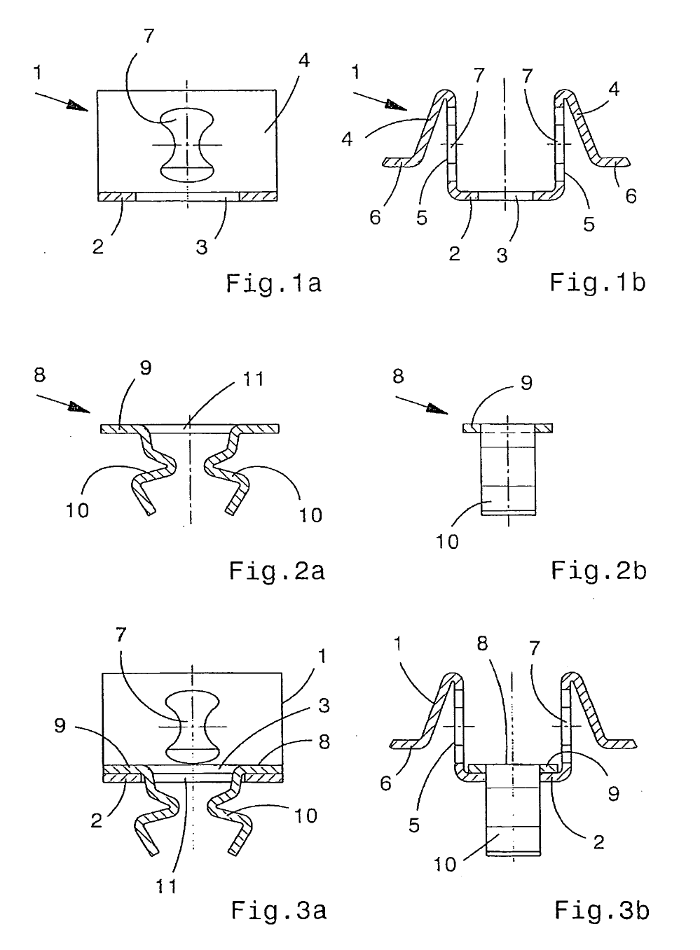

FIGS. 1a and 1b show the mounting part on its own in two views rotated through 90° with respect to each other;

FIGS. 2a and 2b show the expanding part in views rotated through 90° with respect to each other;

FIGS. 3a and 3b show the assembly of mounting part and expanding part with two views rotated through 90° with respect to each other;

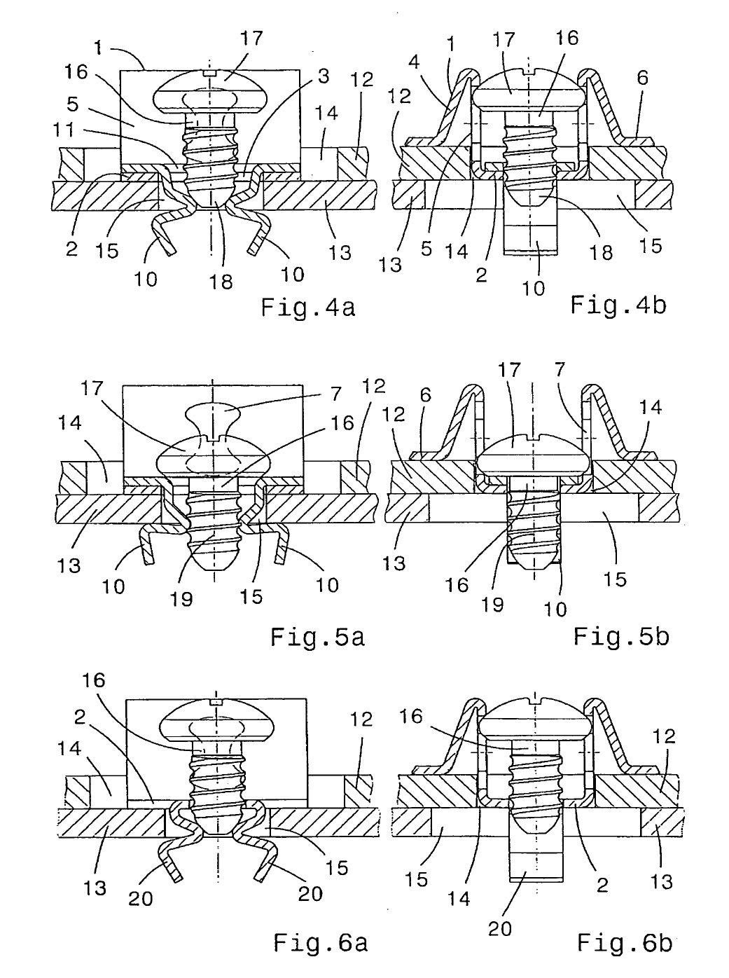

FIGS. 4a and 4b show the fixing clip, attached to two superimposed components in the pre-assembly position;

FIGS. 5a and 5b show the same fixing clip in the holding position;

FIGS. 6a and 6b show a representation similar to that presented in FIGS. 4a and 4b and based on a one-piece fixing clip.

FIGS. 1a and 1b present the mounting part 1 on its own in two views rotated through 90° with respect to each other. Said mounting part 1 consists of the base 2 with the hole passage 3 and the arms 4, which are connected to the base 2 by the supporting parts 5. The arms 4 transition at their ends into seating parts 6, which serve for seating on the upper component, this being presented in FIGS. 4, 5 and 6. The supporting parts 5 are each provided with an opening 7, which serves for engagement and disengagement of a hereinbelow described screw head (see FIGS. 4, 5 and 6).

FIGS. 2a and 2b present the expanding part 8, which is provided with the carrying part 9, out of which the two expanding straps 10 are formed. The hole passage 11 is let into the carrying part 9.

The mounting part presented in FIGS. 1a and 1b and the expanding part 8 presented in FIGS. 2a and 2b are shown in the assembled state in FIGS. 3a and 3b. As can be seen, the expanding part 8 has been inserted into the hole passage 3 of the mounting part 1, this resulting in a single component which essentially is part of the fixing clip according to the invention. In order securely to join the mounting part to the expanding part, the two parts are welded together in the region of the base 2 and the carrying part 9.

FIGS. 4a and 4b present the fixing clip from FIGS. 3a and 3b together with the two superimposed flat components 12 and 13. The component 12 is provided with the penetration 14, the component 13 being provided with the penetration 15. The two penetrations 14 and 15 are in alignment with each other. The fixing clip is so inserted into the two penetrations 14 and 15 that the mounting part rests with its base 2 on the lower component 13, with its supporting parts 5 being passed through the penetration 14 in the upper component 12, the arms 4 resting on the upper component 12 with their seating parts 6 and the two expanding straps 10 projecting through the penetration 15 in the lower component 13.

Inserted into the fixing clip is the cap screw 16, which, in the position presented in FIGS. 4a and 4b, is in the pre-assembly position, in which its head 17 projects into the opening 7 (see FIG. 1a) and is held in engagement therein. The opposite end 18 of the screw 16 to the head 12 is in contact with the expanding straps 10, with the result that the screw is securely held in the pre-assembly position.

FIGS. 5a and 5b present the fixing clip with the screw 16 in the fully screwed-in state, its threaded shank 19 having been screwed between the inner bends of the expanding straps 10, with the result that the expanding straps 10 have been forced outwardly and into engagement with the underside of the component 13. The screw head 17 is in engagement with the lower part of the opening 7, whereby, therefore, in the position presented in FIGS. 5a and 5b, the screw 16 is securely held in the now assumed fixing position. In said position, as already indicated, the expanding straps 10 press on one side of the component 13, while, from the other side, the arms 4 press with their seating parts against the upper component 12, whereby the two components 12 and 13 are braced against each other and are securely held in said position by the fixing clip.

FIGS. 6a and 6b present a variation on the design of the fixing clip shown in FIGS. 1 to 3 and 4a and 4b. The fixing clip presented in FIGS. 6a and 6b is in this case of one-piece design owing to the fact that the expanding straps 20 are formed and bent out of the base 2 of the mounting part, this therefore resulting a one-part design of the fixing clip. With this exception, the operating principle of the fixing clip presented in FIGS. 6a and 6b is the same as that presented hereinbefore with reference to FIGS. 4 and 5. FIGS. 6a and 6b present the fixing clip in the pre-assembly position. Through screwing-in of the screw 16 (as presented in FIGS. 5a and 5b), the fixing clip in FIGS. 6a and 6b can be clamped to the two components 12 and 13 in identical manner to that described hereinbefore with reference to FIGS. 5a and 5b.

It should additionally be pointed out that the penetrations 3 and 11 (see FIGS. 1 and 2) may be of such a size that, even after the fixing clip has been inserted, there is still a certain play between the components 12 and 13, it being possible, for example, for the component 12 to be moved slightly in any direction with respect to the component 13, this possibly being of advantage for the correct attachment of the upper component 12 to the lower component 13.

As can be seen from FIG. 1a, the opening 7 has such a form that, initially in the pre-assembly position (see FIGS. 4a and 4b), the screw head 17 fits into the given form of the opening 7 and is held in said position with a certain degree of security. When the screw 16 is screwed in (see FIGS. 4 and 5), the screw head must overcome the narrow section at the centre of the opening 7, it being necessary for the supporting parts 5 to bend slightly in an outward direction, as a consequence of which the screwing-in of the screw 16 is initially inhibited by a certain resistance. When this resistance has then been overcome, the screw head 17 automatically engages the lower part of the opening 7, where it is securely held. This clearly noticeable transition during the screwing-in of the screw 16, at which the resistance caused by the narrow section in the opening 7 is overcome, tells the user that the screw head 17 has now reached its fixing position, this giving the user a clear indication that the fixing clip has been correctly attached.

1. Fixing clip for joining two superimposed flat components (12, 13) each having one penetration (14, 15) in alignment with the other, characterized by a mounting part (1) with two arms (4) for contact with the upper component (12) and an expanding part (8) attached to the mounting part (1) for spring-loaded engagement of the lower component (13), wherein the mounting part (1) with the expanding part (8) forms a hole passage (3, 11) in alignment with the penetrations (14, 15) and the mounting part (1) receives a cap screw (16), wherein said cap screw (16) penetrates the two penetrations (14, 15) and the hole passage (3, 11) with a threaded shank (19) and is adapted with its head (17) between the two arms (4) to engage the arms (4) both in a pre-assembly position and also in a holding position, out of which positions, as the screw (16) is screwed into the hole passage (3, 11) and as the expanding part (8) expands, the screw (16) transitions into the fixing position, in which the threaded shank (19) holds the expanding part (8) in its expanded position and presses the two components (12, 13) together.

2. Fixing clip according to claim 1, characterized in that the arms (4) have openings (7), said openings (7) being engaged by the head (17) of the screw (16).

3. Fixing clip according to claim 1, characterized in that the expanding part (8) is insertable into the mounting part (1).

4. Fixing clip according to claim 1, characterized in that the expanding part (8) and the mounting part (1) are formed from one piece of sheet metal.

5. Fixing clip according to claim 2, characterized in that the expanding part (8) is insertable into the mounting part (1).

6. Fixing clip according to claim 2, characterized in that the expanding part (8) and the mounting part (1) are formed from one piece of sheet metal.
